(19) United States
(12) Patent Application Publication
(10) Pub. No.: US 2014/0156365 A1
(43) Pub. Date: Jun. 5, 2014

(54) METHOD AND APPARATUS FOR INCENTIVIZING PROFESSIONALS IN A CONSULTATION SYSTEM

(71) Applicant: PEARL.COM LLC, San Francisco, CA (US)

(72) Inventors: Emily A.S.R. Porter, Tiburon, CA (US); Oron Nadiv, San Francisco, CA (US); Andrew Naslund, San Francisco, CA (US)

(73) Assignee: PEARL.COM LLC, San Francisco, CA (US)

(21) Appl. No.: 14/176,007

(22) Filed: Feb. 7, 2014

Related U.S. Application Data
(63) Continuation-in-part of application No. 12/854,838, filed on Aug. 11, 2010.

(51) Int. Cl. G06Q 30/02

(52) U.S. Cl. CPC G06Q 30/0208
USPC 705/14.11

(57) ABSTRACT

In exemplary embodiments, a computer implemented method for incentivizing professionals answering questions or responding to service requests in a consultation system is described where a ranking score is calculated for each professional admitted to the consultation system, and based on the professional's ranking score, he is provided early or delayed access to the user posted questions and requests.

### RELATED APPLICATION

The present application claims the priority benefit and is a continuation-in-part application of U.S. patent application Ser. No. 12/854,838, filed on Aug. 11, 2010 and entitled “Method and Apparatus for Expert Quality Control,” which is incorporated herein by reference.

### FIELD

The present application relates generally to the field of computer technology and, in specific exemplary embodiments, to methods and systems for incentivizing professionals in a consultation system.

### BACKGROUND

Presently, many Internet users turn to the World Wide Web to find answers to questions or other service needs they have. Some websites allow users to post questions on topics of interest to be answered by subject matter experts (professionals), such as doctors, lawyers or mechanics. Among the important factors in the success of such consultation system in providing a satisfactory service and experience to users/customers posting questions or requests to the consultation system seeking answers and services from subject matter experts are the speed with which questions are answered and service provided, the quality of the answers and services, and the quality of the interaction between professionals and users. An exemplary successful consultation system may include hundreds of subject. matter categories, each category including many independent professionals answering posted questions for a fee. Therefore, systems and methods for incentivizing independent professionals to provide high quality, accurate and fast answers and services to users posted questions may be highly a desirable tool in promoting the success of the consultation system.

### BRIEF DESCRIPTION OF DRAWINGS

Various ones of the appended drawings merely illustrate exemplary embodiments of the present invention and cannot be considered as limiting its scope.

FIG. 1 is a diagram of an exemplary environment in which embodiments of the present invention may be practiced.

FIG. 2 is a block diagram of an exemplary quality control engine.

FIG. 3 is a flow chart of an exemplary method of incentivizing professionals to provide quality answers and services to user posted questions and requests.

FIG. 4 is a flow chart of an exemplary system method of calculating bonus points.

FIG. 5 is a simplified block diagram of a digital device within which a set of instructions, for causing the machine to perform any one or more of the methodologies discussed herein, may be executed.

### DETAILED DESCRIPTION

The description that follows includes illustrative systems, methods, technique, instruction sequences, and computing machine program products that embody the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on quality control of professionals, the embodiments are given merely for clarity and disclosure. Alternative embodiments may employ other systems and methods and are considered as being within the scope of the present invention.

Embodiments of the present invention provide systems and methods for incentivizing professionals to provide quality answers and services to user posted questions and requests. In many exemplary embodiments of the consultation system, the professionals who answer posted questions or provide requested services are users of the consultation system, similar to customers who post the questions. Therefore, exerting control over the output of a professional's work operating independently may not be possible and in some cases not desirable. For example, ethics rules for doctors and lawyers prohibit control over a professional's services by non-professionals. Additionally, simply linking professionals' payout to the rating provided by users may result in undesirable consequences. For example, professionals may not answer low and no fee questions or avoid “bad news” questions for fear of receiving low ratings from users. Thus a significant portion of the user posted questions or requests may receive no response.

Bad news questions are questions that provide disappointing news to the user who posted the question. For example a user who posted a question about how to fix his toaster may be disappointed to hear that the cost of fixing the toaster may exceed the value of the toaster. Similarly, a customer asking a question in contract law may be disappointed to find out that she is on the losing side of a dispute.

In alternative embodiments of the present invention, the access to the user. posted questions may be used as a means of incentivizing professionals to meet desirable quality metrics for customer service or other benefits to customers, or the website. In an environment where professionals compete for user posted questions, priority access to user posted questions and requests provides a desirable advantage to the professionals with such priority access. Thus, prioritizing access to the posted questions and requests based on metrics related to a professional's quality becomes a valuable tool.

In alternative embodiments of the present invention, priority access to questions and requests may be based on a professional's ranking score or priority score. In some embodiments priority score is calculated based on one or more factors including the quality of a professional's responses and services, a measure of a professional's customer service skills, (e.g. net promoter score or similar customer survey responses to questions. indicating the likelihood that a customer may recommend the online consultation system and website or a selected professional), a professional's participation in activities that help promote the consultation system's reputation and visibility or the professional's own reputation, a professional's volume of question answered or other services provided, a professional's repeat customer rate, a professional's average earnings per customer, a professional's jurisdiction of licensure or other credentials or characteristics, or seniority status.

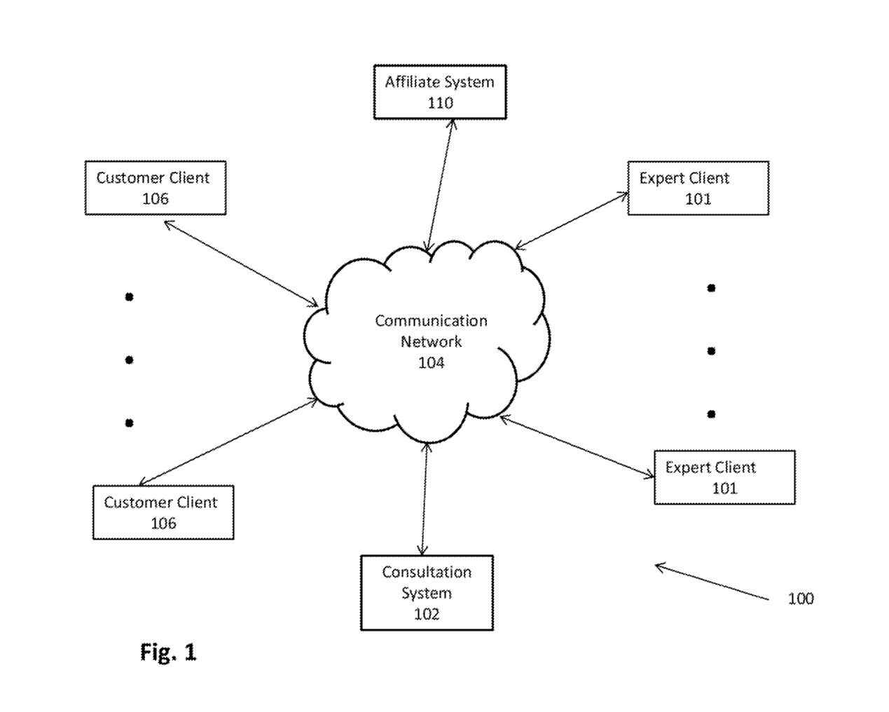

FIG. 1 shows an exemplary environment 100 in which embodiments of the present invention may be practiced. The exemplary environment 100 comprises a consultation system 102 coupled via a communications network 104 to one or more user clients 106 and professional clients 108. The communication network 104 may comprise one or more local area networks or wide area networks, such as, for example, the Internet.

In exemplary embodiments, the consultation system 102 provides a forum where users may post questions or requests for which professionals may provide answers or other services. The consultation system 102 may provide the forum via a website. Because the consultation system 102 is network based, the users using the consultation system 102 and professionals providing answers and services may be geographically dispersed. As a result a professional may provide answers and other services to a user thousands of miles away.

Additionally, the consultation system 102 allows a large number of users and professionals to exchange information at the same time and at any time.

By using embodiments of the present invention, a user posting a question or other request can easily obtain an answer or service tailored to his or her specific question or request posted to the consultation system 102. Accordingly, systems and methods discussed herein may obviate a need for additional searching for answers or services, which may have the technical effect of reducing computing resources used by one or more devices within the system. Examples of such computing resources include, without limitation, processor cycles, network traffic, memory usage, storage space, and power consumption. Furthermore, the systems and methods disclosed in the present invention allow for users to access reliable information from verified sources, allowing users to have confidence in the ultimate solutions they obtain to their specific problems.

In various embodiments, a user may pose a question or request and one or more professionals may provide answers or services. In various embodiments, the question or request may be matched with a category of professionals by user selection, a keyword based algorithm, or other sorting mechanism. A back-and-forth communication can occur. The user may accept an answer or service provided by one of the professionals. By accepting the answer or service, the user validates the professional's answer or service which, in turn, may boost a score or rating associated with the professional. In exemplary embodiments of the present invention, the professional provides an answer or service to a user in exchange for a fee. The user may also pay the professional for ally accepted answers or services and may add a bonus. The exemplary user client 106 is a device associated with a user accessing the consultation system 102 (e.g., via a website associated with the consultation system 102). The user (also referred to as a customer) may comprise any individual who has a question or request or is interested in finding answers to previously asked questions or requests. The user client 106 comprises a computing device (e.g., laptop, PDA, cellular phone) which has communication network access ability. For example, the user client 106 may be a desktop computer initiating a browser for access to information on the communication network 104.

In exemplary embodiments, the professional client 108 is a device associated with a professional. The professional, by definition, may be any person that has knowledge and appropriate qualifications relating to a particular subject matter. Some examples of professional subject matters include health (e.g., dental), medical (e.g., eye or pediatrics), legal (e.g., employment, intellectual property, or personal injury law), car repair, tax related questions, compiler service and/or use, electronics, parenting, relationships, and so forth. Almost any subject matter that may be of interest to users for which professionals have knowledge and appropriate qualifications may be contemplated. The professional may, but does not necessarily need to, have a license, certification or degree in a particular subject matter. For example, a car professional may have practical experience in terms of working the past 20 years at a car repair shop.

The professional client 108 may comprise a computing device (e.g., laptop, PDA, cellular phone) which has communication network access ability. For example, the professional client 108 may be a desktop computer initiating a browser to exchange information via the communication network 104 with the consultation system 102.

In accordance with one embodiment, an affiliate system 110 may be provided in the exemplary environment 100. The affiliate system 110 may comprise an affiliate website which may include some of the components of the consultation system 102 or direct their users to the consultation system 102. For example, the affiliate system 110 may provide a website for a medical group. A link or question/request box may be provided on the affiliate website to allow patients of the medical group to ask questions or make requests. Answers or services in response to the questions or requests may be provided, in part, from the consultation system 102, or the patient asking the question or for the service may be directed to the consultation system 102 for the answer. The patients may, in some cases, only have. access to certain categories or professionals. In one embodiment, a RSS feed may be used to feed data from the consultation system 102 to the affiliate system 110. The users of the affiliate system 110 may be tagged with the affiliate depending on if and how the users are registered with the consultation system 102. It should be noted that the affiliate system 110 may comprise any type or category of affiliate sites. In some cases, the affiliate system 110 may involve questions being answered or services provided by the affiliate or persons involved with the affiliate.

The environment 100 of FIG. 1 is exemplary. Alternative embodiments may comprise any number of consultation systems 102, user clients 106, professional clients 108, and affiliate systems 110 coupled together via any type of one or more communication networks 104, and still be within the scope of exemplary embodiments of the present invention. For example, while only one consultation system 102 is shown in the environment 100, alternative embodiments may comprise more than one consultation system 102. For instance, the consultation systems 102 may be regionally established.

Exemplary embodiments of the consultation system 102 may include various engines or modules (not shown here) designed to functions related to operations of the consultation system 102. For example, certain embodiments of the consultation system 102 include a graphical interface engine, an accounts engine, a consultation analysis engine, a professional verification engine, a quality control engine, and a payment engine communicatively coupled together. The functioning of each engine is described in detail in the pending U.S. patent application Ser. No. 12/854,838, filed on Aug. 11, 2010, entitled “Method and Apparatus for Expert Quality Control,” The present application is a continuation in-part-of the U.S. application Ser. No. 12/854,838 and includes Emily Porter as a common inventor.

The exemplary graphical interface engine generates graphical representations provided via the web page. The exemplary accounts engine sets up and maintains user accounts with the consultation system 102. The consultation analysis engine manages answers and services in response to questions and requests which have been posted to the consultation system 102. Acceptance and non-acceptance actions are tracked by the consultation analysis engine. The exemplary payment engine manages the payment of fees. In accordance with exemplary embodiments, users pay professionals for accepted answers and services to their questions and other requests.

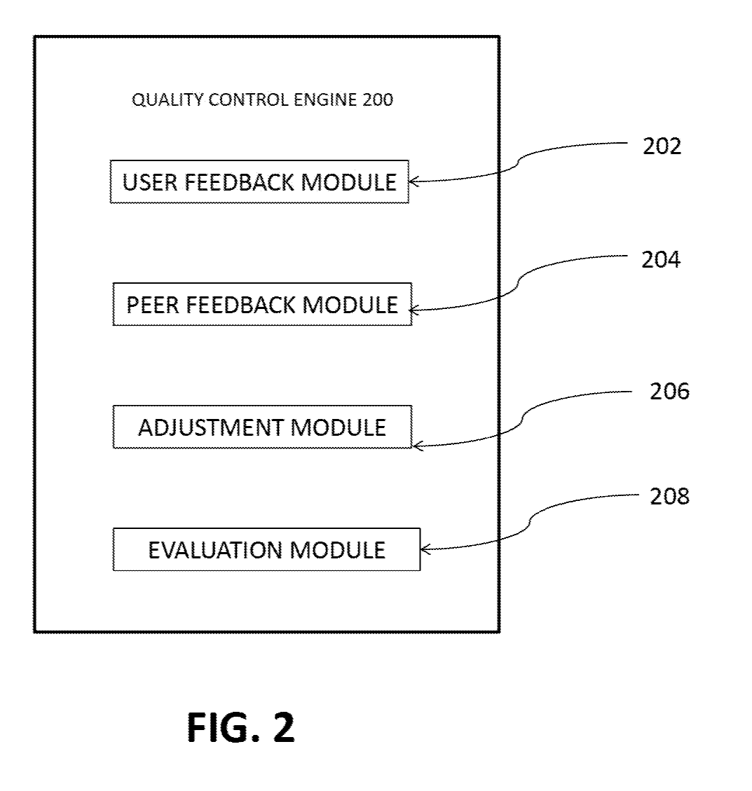

The exemplary professional verification engine performs verification and acceptance of professionals. In exemplary embodiments, the quality control engine evaluates professionals in order to ensure professionals provide quality answers and services to questions and requests posted to the consultation system 102. The evaluation may comprise scoring or ranking professionals based on various elements. For example, the quality control engine may access and review feedback and information associated with each professional and score each professional accordingly. The quality control engine may also review other factors Which may increase or decrease a professional's score or ranking, including a professional's customer service Skills the accuracy of the professional's answers, participation in activities that promote the consultation system and/or the professional's reputation and visibility, a professional's volume of question answered or other services provided, a professional's repeat customer rate, a professional's average earnings per customer, and a professional's jurisdiction of licensure or other credentials or characteristics, or seniority status. The quality control engine will be discussed further in connection with FIG. 2. Referring now to FIG. 2, the exemplary quality control engine is shown in more detail. The quality control engine 200 evaluates professionals in order to maintain quality in the consultation system 102. The evaluation may comprise scoring or ranking professionals. The quality control engine 200 may comprise a user feedback module 202, a peer feedback module 204, an adjustment module 206, and an evaluation module 208 communicatively coupled together. Further quality control modules may be provided as needed to incorporate other factors which may be used to score or rank experts, such as professional and answer characteristics and statistics, and third-party sources of information and feedback. In exemplary embodiments of the present invention, the consultation analysis engine may manage and control professionals' access to the user posted questions and requests and the consultation analysis engine modifies each professional's ability to view the question/request list based on the professional's ranking score. In alternative embodiments, an account engine, consultation analysis engine or an expert verification engine may be used to manage and control all or some aspects of professionals' access to user posted questions and requests.

Referring back to the quality control engine 200, a user feedback module 202 manages feedback based on users' experiences with professionals. The user feedback may include direct feedback such as, for example, written comments provided by users, a positive/neutral/negative scoring, complaints, and user surveys. Indirect feedback may also be included in the user feedback. Examples of indirect feedback include how often users accept an professional's answer or service, give bonuses to professionals, request refunds, choose to receive answers from or not receive answers from the professional (e.g., does not want to receive any responses from the professional in the future), directly or indirectly rate an professional's viewable profile, and how often users return to ask another question after receiving an answer from the professional.

The peer feedback module 204 manages feedback provided by other professionals on the consultation system 102. For example, a first professional may file a positive or negative report on a second professional or the second professional's answer. The report may indicate whether the first professional agrees with the posted answer of the second professional, the reason for the agreement or disagreement, or a new model answer. The report may indicate the type of problem being reported (e.g., whether the report is being submitted due to a problem with the correctness or completeness of an answer, an unprofessional remark or tone, or potential violations of the law or applicable agreements). In sonic embodiments, additional peer review may be solicited and/or provided regarding the report filed by the first professional. Peer feedback may also include professionals scoring randomly, systematically, or manually selected anonymized or non-anonymized answers or services posted on or through the consultation system 102. For example, professional quality surveys may be periodically conducted in certain categories regarding the best or worst professionals. In some embodiments, the professionals solicited for their additional peer review may be selected at random, based on their own characteristics, by vote of their peers, or by a system of points or other measurements obtained through the peer feedback module 204. In some embodiments, third-party non-users of the site, for example, affiliate persons or entities, professors of the same subject matter as the category of answers or professionals, or others may also provide input into reviews or rankings of the characteristics of answers or professionals.

The exemplary adjustment module 206 manages other factors which may adjust the score or rank of the professionals. These factors may include public or non-public, miscellaneous actions associated with the consultation system 102. The actions may include, for example, number of years on the consultation system 102, awards and titles (e.g., mentor, moderator, arbitrator) received on the consultation system 102, uniqueness of posts, tune between customer question and professional response, number of links in posts, and data associated with the post. the number of times a user returns to the consultation. system 102 asking an unrelated subsequent question in the same or other categories as her first question, the number of times a user posts a question to the consultation system 102, specifically asking for the same professional. The data associated with the post may include analysis of the number of words in a post, number of answers posted before an acceptance of a post is received, and spelling and grammar in posts, for example. Other factors may also include number of years in the professional's profession and number of licenses, certifications, or credentials obtained by the professional.

Miscellaneous actions may also include non-public, actions (e.g., actions which may not be evident to users). For example, the professional may take more shares of non-paying or new users, thus taking a bigger monetary risk. Additionally, the professional may take more than his or her share of had news questions. The professional may also move questions posted in a wrong category to a correct category. In another example, the professional may assist with media, marketing, and public relations efforts (e.g., speaking to the press). It would be apparent to one of skilled in the art that almost any type of factor that may affect the scoring or ranking of professionals or affect or improve the operation of the online consultation system 102 may be utilized, and the above provided factors are only examples.

The exemplary evaluation module 208 evaluates the professionals and outputs a useable result. The evaluation may be based on user feedback, peer feedback, adjustment factors, or any combination of these. In some embodiments, the evaluation module 208 may generate two results: a public result and an internal result. The public result may be viewable by the public or at least other professionals, and may be driven more by user and peer feedback. The internal result may not be viewable by the public, but may be used by the consultation system 102 for internal functions. For example, the consultation system 102 may limit the number of professionals in a category or answers or services a professional can give. Thus, the internal result may be used to warn, limit access to the consultation system 102, or remove or limit the lowest scoring professionals in the category (e.g., based on providing poor responses or services, not interacting professionally or politely with others, or violating site policies). In another example, the internal result may be used to determine an amount that a professional may be paid for posting accepted answers (e.g., the better the score, the better the pay amount). In exemplary embodiments, the internal result may be driven more by factors associated with the adjustment module 206. The results may be provided graphically or numerically.

In some embodiments, conditions may be automatically or manually set to limit functions of professionals. For example, a new professional in a category may not be allowed to post a response after a senior professional (e.g., professional having been on the consultation system 120 longer) has already posted a response. Additionally, peer review reporting privileges of a new professional may be withheld until the new professional reaches a certain threshold of questions answered, responses accepted, or time on the consultation system 120. Alternatively, peer review reporting privileges of non-new professionals may be revoked if the non-new professional files too many reports that have been disagreed with by other professionals. In another example, professionals may be limited to only a set number of questions per day that they can respond to in order to encourage quality over quantity.

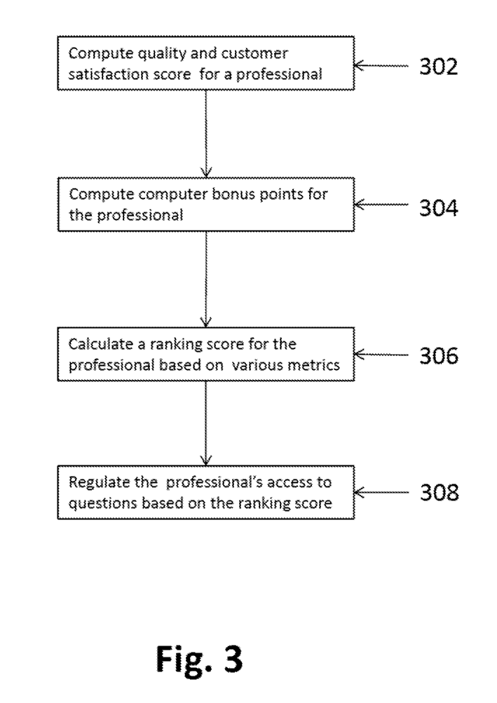

FIG. 3 is a flowchart of an exemplary method for calculating a ranking score for each professional. In exemplary embodiments the ranking scores may be calculated by the quality control engine, using data computed by various modules, including, the user feedback module 202, the peer feedback module 204, the adjustment module 206, and the evaluation module 208. In alternative embodiments, the ranking score may be calculated by the evaluation module 208 alone.

In exemplary embodiments, not all professionals must be ranked for the system to work. Sometimes only the top professionals will be identified or ranked, sometimes only the worst, sometimes the newest who do not yet have statistically significant quality data, and sometimes a combination will be identified or ranked.

In reference to FIG. 3, the process of calculating a ranking score for a professional starts in operation 302 with the quality control engine 200 computing a quality score for each professional admitted to answer questions or respond to requests in a given subject matter category. hi exemplary embodiments of the present invention, the quality score for each professional may be computed based on a combination of answer and service quality parameters and customer service parameters. In one embodiment, the answer and service quality parameters may measure the correctness and accuracy of the answer provided from a technical point of view. The answer or service accuracy may be judged by peer review allowing other admitted professionals to a given subject matter category to provide opinions on the accuracy of the answers or services provided by a professional. In certain embodiments. professional advisory panels may review answers and services provided by professionals for accuracy. Other technical factors Used to measure the quality of a professional's answer and services may include, use of clear and precise communication language, including answers that are free of technical jargon, free from spelling errors, and make correct use Of grammar, when responding to a user question. Additional quality factors may include abidance by the professional of his or her applicable ethical rules of conduct, and/or abidance by the terms of service of the consultation system. 102.

In some embodiments, a customer service score may be calculated for each professional based on feedback from customers. Since the perception of the quality of service provided is subjective, how the professional interacts with customers and how customers perceive of the professional may be an important component of measuring the quality of the answers and services the professional provides. In some embodiments of the present invention, customer service surveys, rating by customers of their interactions with a professional are used to calculate a customer service score.

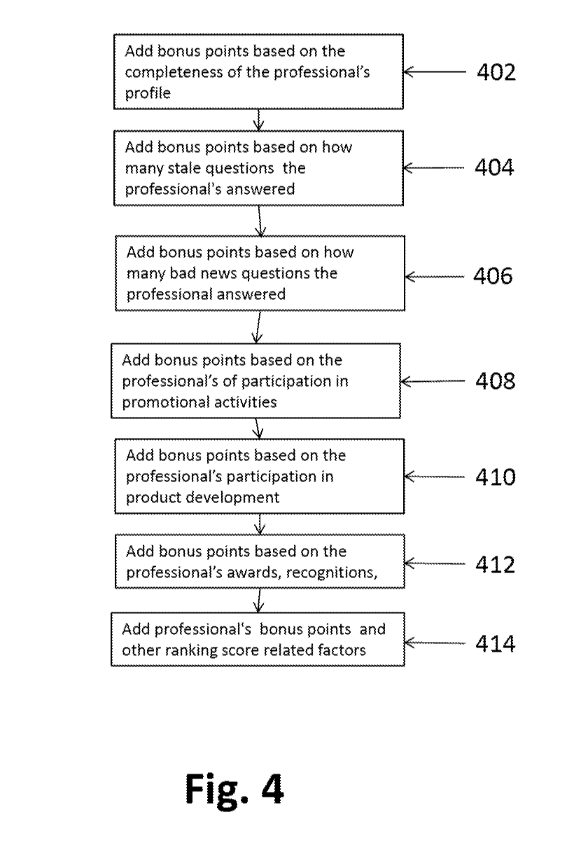

In operation 304, the bonus points accumulated by a professional are computed and added to each professional's score. Bonus points are accumulated by a professional's activities that help promote the consultation system 102. In certain embodiments of the present invention, negative bonus points may be accumulated if the professional's behavior affects the reputation of the consultation system negatively. Bonus points shall be discussed in further detail in FIG. 4.

In operation 306 a ranking score for each professional may be computed based on factors including the professional's quality score, customer service score and bonus. points accumulated.

In operation 308, the professional's access to the posted question is adjusted based on his or her ranking score. In one embodiment, the higher the ranking score of a professional, the sooner he or she may access user posted questions and requests and select a question or request to respond to. Alternatively all professionals with a ranking score above a given threshold may have a set time advantage in accessing user posted questions or requests. In an exemplary implementation, the time advantage may be 30 seconds or one minute. In alternative embodiments, the time advantage may vary with the time of day, the number of professionals available to answer questions, the number of questions, the subject matter category of the questions as well as other factors. In a setting Where professionals get paid for answering questions and responding to requests, a time advantage in accessing questions can be a great incentive because it directly affects the professional's potential income from the answering questions on the consultation system 102.

In alternative embodiments, professionals with ranking scores below a given threshold may be penalized by having their access to posted questions and requests delayed by a set time. The professional's delayed access to user posted questions may remain in place until the professional increases his or her ranking score by performing activities including answering low or no pay questions, answering “bad news” questions, improving their consultation system 102 profile, participating in promotional activities that promote the professional and/or the consultation system, etc.

In alternative embodiments, certain low pay, no pay questions or bad news questions or services may be tagged as immunity eligible questions or services. Immunity eligible questions may provide the professionals attempting to answer to provide the desired services immunity with regards to negative customer feedbacks. The immunity offer encourages more professionals to attempt to answer or provide services for zero price, low price and “bad news” questions and services.

In alternative embodiments, professionals with certain jurisdictional characteristics or without statistically significant quality data may be advantaged of disadvantaged regarding their access to posted questions and requests.

In an exemplary embodiment of the present invention, for each professional or set of professionals, a ranking score or list of professionals is stored in a table of spreadsheet and a corresponding. question access priority access or delayed access time value is attributed to the professional or set of professionals based on his or her ranking score and stored in a corresponding entry in the question access time table. In one embodiment of the present invention, the initial question access time value for each new professional is set to zero. Subsequently, the initial question access time value is increased or decreased based on the professional's ranking score. In an alternative embodiment, the question access time value is set to a negative value or a delay (e.g. 30 seconds) and the question access value is increased or decreased subsequently based on the professional's ranking score.

FIG. 4 shows a flowchart of an exemplary method for calculating a professional's bonus points. In exemplary embodiments of the present invention, professionals are independent operators, and as such, the consultation system 102 does not exert any direct control over their activities. For certain subject categories such as law or medicine, any direct control of the answers of a professional may be prohibited by law and rules of professional conduct. In such a setting, means of incentivizing professionals to provide good quality answers without actually controlling a professional's answer is valuable. In addition, any voluntary activities that may promote the consultation system 102 may be rewarded. A non-exhaustive example of such activities that may be performed by a professional and the resulting effect on a professional's ranking score is described below.

With reference to FIG. 4, in operation 402 bonus points are awarded to the professional if his or her profile is complete, e.g. it includes a photo, a full biography, interesting facts that may help promote the expert and the consultation system 102. If the professional's profile identifies that the professional has or has recently gained expertize in subject matter categories that have a shortage of qualified professionals, the professional may be awarded with additional bonus points.

In operation 404, the bonus points are awarded to the professional based on the number of stale (old) questions he or she answers. Stale questions may include questions that require more effort and research than warranted by the compensation the user is offering for the answer. At the same time, the goal of a successful consultation system 102 may include providing answers to the highest percentage of questions posted by users, regardless of the price. In such a setting, the consultation system 102 may reward professionals who answer stale questions with a bonus points. In alternative embodiments, professionals who do not answer a minimum number of stale questions may receive strikes (negative bonus points) against them.

In operation 406, bonus points may be awarded to the professional for each “bad news” question the professional answered. Bad news questions may include questions. where the news is not positive and thus the user may not be happy with the response he or she receives, regardless of the quality or accuracy of the answer, or the level of customer service provided by the professional. Since an unhappy user is more likely to be an unsatisfied user and rate the professional's service negatively, professionals may be reluctant to answer bad news questions. Additionally, users may be less willing to pay for a had news question. For these reasons, bad news questions may go unanswered. In order to incentivize professionals to answer had news questions, the consultation system 102 may provide bonus points to the professional answering a had news questions. In alternative embodiments, the consultation system 102 may provide “immunity” from user feedback for some or all bad news questions. In alternative embodiments, the professionals who select had news, stale questions, and low fee or no fee questions may opt-out of answering the question without any penalty. The opt-out option may make it more likely for professionals to attempt to answer the bad news, stale questions, and low fee or no fee questions.

In operation 408, bonus points are awarded for the professional's participation in activities that promotes the consultation system 102. Promotional activities may include participation in marketing and advertising campaigns, public relations outreach, providing content (e.g. articles on topics of interest to users), conducting webinars or inviting customers to return to the website, etc. Since promotional activities help promote both the professional and the consultation system 102, the professionals participating in such activities may be rewarded with bonus points.

In operation 410, a professional's cooperation and participation in development, beta testing and launch of new products may be awarded by bonus points.

In operation 412, a professional's successes and awards and recognition independent of the consultation system may be awarded by consultation system 102 by awarding bonus points to the professional. A professional's notoriety may be beneficial to the consultation system and thus rewarded. Additionally, other factors may qualify a professional to receive bonus points. For example, a professional's volume of question answered or other services provided, a professional's repeat customer rate, a professional's average earnings per customer, a professional's jurisdiction of licensure or other credentials or characteristics, or seniority status may all be counted towards qualifying a professional to receive bonus points. In operation 414, for each professional, all the bonus points awarded during a period (e.g. a month or a quarter) are added and any strikes may be deducted to calculate a total bonus point score for each professional. As previously described, for each professional, his or her awarded bonus point total is used along with other quality scores to calculate a ranking score which would affect the professional's access privileges to the questions posted to the consultation system 102. Additionally, other factors affecting the professional's ranking score is used to calculate the professional's total ranking score, including but not limited to a customer satisfaction score, a peer review quality score, a seniority status, a per customer earnings or repeat metric, jurisdiction of licensure, volume of question answered or other services provided, repeat customer rate, average earnings per customer, seniority status and bonus points accumulated by performing activities that promotes the consultation system.

### Modules, Components, and Logic

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain exemplary embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (AMC), or array) to perform certain operations. A module may also comprise programmable logic or circuitry (e.g. as encompassed within a general-purpose processor or other programmable processor) that is temporarily configured by software or firmware to perform certain operations. It will be appreciated that a decision to implement a module mechanically, in the dedicated and permanently configured circuitry or in temporarily configured circuitry (e.g., configured by software) may be driven by, for example, cost, time, energy-usage, and package size considerations.

Accordingly, the term module should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

### Exemplary Machine Architecture and Machine-Readable Medium

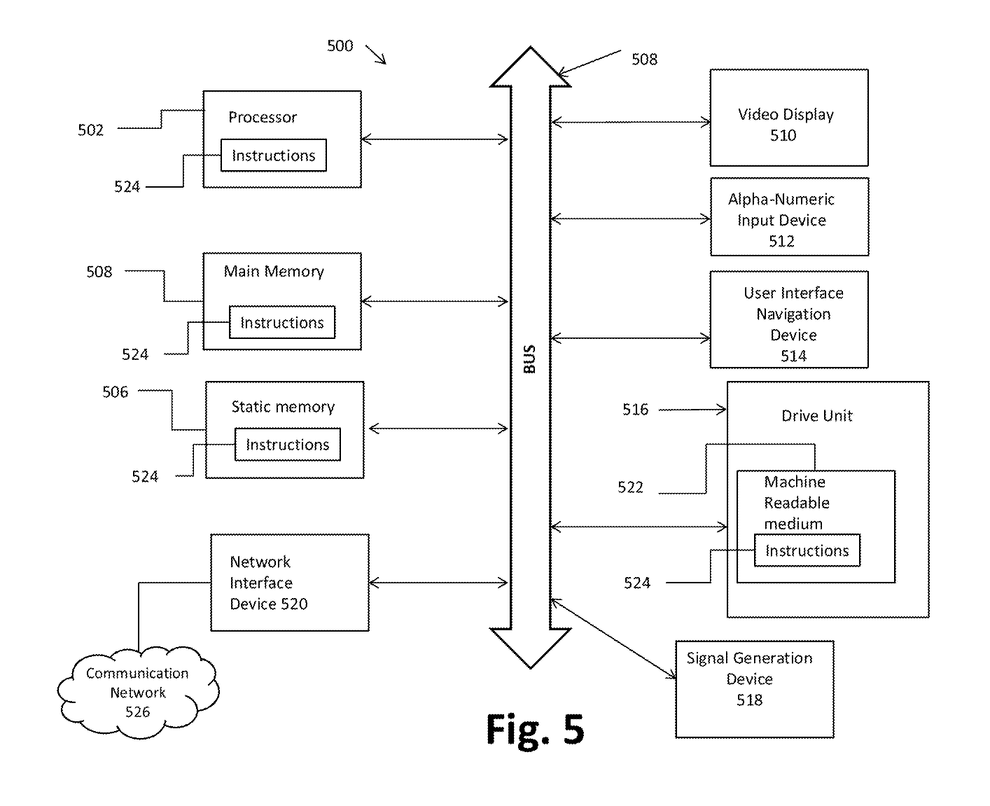

With reference to FIG. 5, an exemplary embodiment extends to a machine in the exemplary form of a computer system 500 within which instructions for causing the machine to perform any one or more of the methodologies discussed herein may be executed. In exemplary embodiments, the computer system 500 may be any one or more of the user client 106, the expert client 108, affiliate system 110, and servers of the consultation system 102. In alternative exemplary embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 may include a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). In exemplary embodiments, the computer system 500 also includes one or more of an alpha-numeric input device 512 (e.g., a keyboard), a user interface (151) navigation device or cursor control device 514 (e.g., a mouse), a disk drive unit 516, a signal generation device 518 (e.g., a speaker), and a network interface device 520.

### Machine-Readable Medium

The disk drive unit 516 includes a machine-readable medium 522 on which is stored one of more sets of instructions 524 and data structures (e.g., software instructions) embodying or used by any one or more of the methodologies or functions described herein. The instructions 524 may also reside, completely or at least partially, within the main memory 504 or within the processor 502 during execution thereof by the computer system 500, the main memory 504 and the processor 502 also constituting machine-readable media.

While the machine-readable medium 522 is shown in an exemplary embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying, instructions for execution by the machine and that cause the machine to perform any one or more of the methodologies of embodiments of the present invention, or that is capable of storing, encoding, or carrying data structures used by or associated with such instructions. The term “machine-readable medium” shall accordingly be taken to include, but not be limited to, solid-state memories and optical and magnetic media. Specific examples of machine-readable media include non-volatile memory, including by way of exemplary semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks. The tem “machine-readable medium” shall also be taken to include any non-transitory storage medium.

### Transmission Medium

The instructions 524 may further be transmitted or received over a communications network 526 using a transmission medium via the network interface device 520 and utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Win and WiMax networks). The term “transmission medium” shall be taken to include any intangible medium that is capable of storing, encoding, or carrying instructions for execution by the machine, and includes digital or analog communications signals or other intangible medium to facilitate communication of such software.

Although an overview of the inventive subject matter has been described with reference to specific exemplary embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fill within a scope of various embodiments of the present invention. In general, structures and functionality presented as separate resources in the exemplary configurations may be implemented as a combined structure or resource. Similarly, structures and functionality presented as a single resource may be implemented as separate resources.

These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A computer implemented method of incentivizing professionals answering or responding to user posted questions or requests in a consultation system, the computer implemented method comprising:
calculating a ranking score for each professional admitted to the consultation system; and
providing early or delayed access to the user posted questions/requests to the professional based on the ranking score.

2. The method of claim 1, wherein for each professional the ranking score is calculated based on at least one of a customer satisfaction score, a peer review quality score a seniority status, a per customer earnings or repeat metric, jurisdiction of licensure, volume of question answered or other services provided, repeat customer rate, average earnings per customer, seniority status and bonus points accumulated by performing activities that promotes the consultation system.

3. The method of claim 1, wherein the customer satisfaction score is a net promoted-based score.

4. The method of claim 1, wherein bonus points are awarded to each professional based on the level of participation of the professional in activities promoting the consultation system.

5. The method of claim 4, wherein the activities promoting the consultation system include writing blog articles, creating a complete profile, participating in consultation system product development, testing, participating in public relations activities.

6. The method of claim 4, wherein the bonus points are awarded based on the number of stale questions the professional answers.

7. The method of claim 1, wherein the bonus points are awarded based on the number of “bad news” questions the professional answers,

8. The method of claim 1, further comprising:
incentivizing professionals by providing immunity from customer rating to the professional answering immunity eligible questions.

9. The method of claim 8, wherein the immunity eligible questions include stale, low fee or no fee questions, and bad news questions.

10. The method of claim 7, further comprising:
providing the professional answering the bad news question with a template response.

11. The method of claim 1, further comprising:
providing an opt out option to the professional that selects a stale, low price or bad news question to answer.

12. The method of claim 1, further comprising:
providing the professional a larger share of a fee for the posted question based the professional's ranking score.

13. The method of claim 1, wherein the ranking, score of the professional is increased based on the professional's activities outside of the consultation system that promotes the professional's public profile.

14. The method of claim 1, wherein a new professional is provided delayed access to the question list during a probationary period.

15. The method of claim 1, wherein the professional with ranking scores below a threshold is provided delayed access to the question list during a probationary period,

16. The method of claim 14, further comprising using the ranking score to provide the professional with privileges not related to question access tune.

17. The method of claim 1, wherein an access time value for the early or delayed access is between negative days up to positive days.

18. The method of claim 17, wherein the professional's ranking score and the corresponding professional's early or delayed access time value are recorded as entries in a question access time table for each professional.

19. A machine-readable storage medium having embodied thereon instructions w when executed by at least one processor, causes a machine to perform operations comprising:
calculating a ranking score for each professional admitted to the consultation system, wherein for each professional the ranking score is calculated based on at least one of a customer satisfaction score, a peer review quality score, a seniority status, a per customer earnings or repeat metric, jurisdiction of licensure, volume of question answered or other services provided, repeat customer rate, average earnings per customer, seniority status and bonus points accumulated by performing activities that promotes the consultation system; and
providing early access to the user posted questions to the professional with a high ranking score.
